(19) United States
(12) Patent Application Publication
(10) Pub. No.: US 2026/0236245 A1
(43) Pub. Date: Aug. 13, 2026

(54) SYSTEM AND METHOD FOR DYNAMIC SOFTWARE SELECTION FOR A WORK MACHINE BASED ON PERFORMANCE METRICS

(71) Applicant: Deere & Company, Moline, IL (US)

(72) Inventors: Andrew Mark Colosky, Urbandale, IA (US); Matthew Paul Stemper, Johnston, IA (US)

(21) Appl. No.: 19/048,283

(22) Filed: Feb. 7, 2025

(51) Int. Cl. G06F 8/65

(52) U.S. Cl. CPC G06F 8/65

(57) ABSTRACT

A system and method are provided for dynamic software selection for a work machine based on determined operational metrics. Update software modules are received at an onboard controller for a work machine, and an updated software package is generated comprising at least one of the received update software modules in memory associated with the onboard controller. A performance level is predicted for at least one operational metric corresponding with execution of the updated software package, and a corresponding actual performance level is automatically detected for each of the at least one operational metric. Based on a comparison between the respective actual and predicted performance levels, an intervention event is dynamically determined with respect to a continued execution of the updated software package. For example, if the performance of the work machine is worse with the update, the software may be automatically reverted to a preceding version of the software package.

### FIELD OF THE DISCLOSURE

The present disclosure relates generally to software updates for work machines, and more particularly to a method and system for dynamically selecting software for work machines based on monitored performance metrics.

### BACKGROUND

Work machines as discussed herein may include self-propelled work vehicles, implements towed by or otherwise mounted to self-propelled work vehicles, stationary machines or devices, plants comprising groups of machines or devices, or more generally any machine or group of machines having one or more programmable control units wherein software is utilized. With the potential for individually deployable software components in the control systems for work machines, and particularly with the capability of such work machines to remotely download and quickly operate using updates to software components, the potential likewise exists for work machine performance to be negatively impacted by a software update before such an impact becomes apparent to the operator.

Accordingly, the operator, administrator, fleet management, or the like may prefer to only provide software updates to the work machine in a controlled environment where performance of the work machine can be thoroughly tested before returning to operation. However, there may be costs associated with this decision as well, such as unnecessary downtime and opportunity cost, as well as an amount of operation without the updated software and accordingly without the expected benefits therefrom.

### BRIEF SUMMARY

The current disclosure provides an enhancement to conventional systems, at least in part by introducing a novel system and method to determine whether a software upgrade for a control system of a work machine has been successful, and to further dynamically act upon such a determination.

According to a first embodiment, a computer-implemented method is provided for dynamic software selection for a work machine based on determined operational metrics. One or more update software modules are received at an onboard controller for a work machine, and an updated software package is generated comprising at least one of the received one or more update software modules in memory associated with the onboard controller. A performance level is predicted for at least one operational metric corresponding with execution of the updated software package, and a corresponding actual performance level is automatically detected for each of the at least one operational metric. Based on a comparison between the respective actual and predicted performance levels, an intervention event is dynamically determined with respect to a continued execution of the updated software package.

In one exemplary and optional aspect according to the above-referenced first embodiment, the method may comprise determining no intervention event is required based on the detected actual performance levels meeting or exceeding the corresponding predicted performance levels for each of the at least one operational metric.

In another exemplary and optional aspect according to the above-referenced first embodiment, the one or more update software modules are received and utilized to generate an updated software package by a plurality of work machines; a comparison with respect to respective predicted performance levels is provided for each of the plurality of work machines having executed the updated software package and producing actual performance levels; and an intervention event is dynamically determined with respect to a continued execution of the updated software package for each of the plurality of work machines.

In another exemplary and optional aspect according to the above-referenced first embodiment, for a first error range based on the comparison between the detected actual performance levels and the corresponding predicted performance levels for each of the at least one operational metric, the determined intervention event may comprise an automatic switching from the updated software package to an alternative software package.

In another exemplary and optional aspect according to the above-referenced first embodiment, switching to the alternative software package may comprise reversion to a preceding software package lacking the at least one of the received one or more update software modules.

In another exemplary and optional aspect according to the above-referenced first embodiment, the determined intervention event comprising the automatic switching from the updated software package to the alternative software package may be dependent on the alternative software package being determined as valid for further execution with respect to the work machine.

In another exemplary and optional aspect according to the above-referenced first embodiment, upon determining that a first alternative software package is invalid for further execution with respect to the work machine, the determined intervention event may comprise automatic switching from the updated software package to a second alternative software package.

In another exemplary and optional aspect according to the above-referenced first embodiment, a determination as to whether the alternative software package is valid may be dependent at least in part on an operation being performed or to be performed by the work machine.

In another exemplary and optional aspect according to the above-referenced first embodiment, the method may include determining that switching to the alternative software package is not valid during an operation currently being performed, and further switching to the alternative software package upon completion of the operation currently being performed.

In another exemplary and optional aspect according to the above-referenced first embodiment, the method may include planning a test operation for the work machine wherein the updated software package is executed for the dynamically determining of the intervention event prior to a working operation for the work machine.

In another exemplary and optional aspect according to the above-referenced first embodiment, the test operation may be planned to provide test inputs corresponding to actual performance levels for each of the at least one operational metric.

In another exemplary and optional aspect according to the above-referenced first embodiment, one or more of the at least one operational metric may be defined based on operator input to the controller via a user interface.

In another exemplary and optional aspect according to the above-referenced first embodiment, the corresponding actual performance levels for the one or more of the at least one operational metric may be provided based on operator input to the controller via the user interface.

In a second embodiment, a system as disclosed herein comprises one or more work machines each respectively comprising an onboard controller and memory associated therewith, and one or more processors configured to direct the performance of steps in a method according to the above-referenced first embodiment and optionally one or more of the exemplary aspects associated therewith. The one or more processors may for example be distributed across each of the work machines. Alternatively, or in addition, at least one of the one or more processors may be associated with a cloud network communicatively linked withe the onboard controller.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a block diagram representing a system including an onboard work machine controller according to an embodiment of the present disclosure.

FIG. 2 is a block diagram representing a software performance analyzer according to an embodiment of the present disclosure.

FIG. 3 is a flowchart representing a method according to an embodiment of the present disclosure, from a software release stage to a software performance monitoring stage.

FIG. 4 is a flowchart representing a method according to an embodiment of the present disclosure, in the context of software performance monitoring and conditional reversion stages.

### DETAILED DESCRIPTION

The implementations disclosed in the above drawings and the following detailed description are not intended to be exhaustive or to limit the present disclosure to these implementations. Any alterations and further modifications to the described devices, systems, methods, and any further application of the principles of the present disclosure are fully contemplated as would normally occur to one skilled in the art to which the disclosure relates. In particular, it is fully contemplated that the features, components, steps, or a combination thereof described with respect to one example may be combined with the features, components, steps, or a combination thereof described with respect to other examples of the present disclosure.

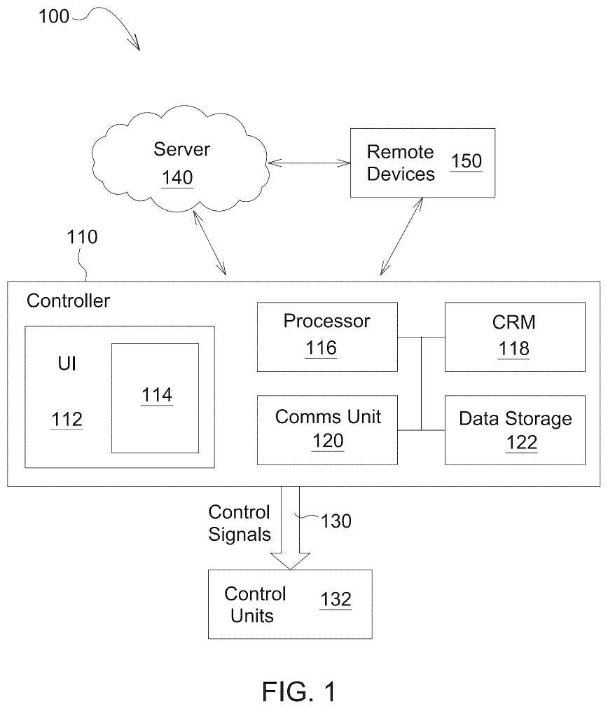

As illustrated in FIG. 1, an exemplary system 100 as disclosed herein may include at least one onboard controller 110 for at least one work machine, as communicatively and functionally linked to a cloud server network 140 and one or more remote user computing devices 150 such as may for example be associated with a hosted fleet management system.

A “work machine” within the scope of the present disclosure may include work machines that travel, self-propelled or otherwise, through a work area and may include a combine harvester, tractor, sprayer, excavator, track loader, feller buncher, dump truck, road milling machine, or the like. However, such a characterization is not intended as limiting on the scope of the present disclosure unless otherwise specifically noted herein, and in some embodiments a work machine may include implements associated with a work vehicle, or stationary work machines, or plants comprising one or more stationary work machines, etc.

An onboard controller 110 for a work machine may include an electronic control unit or equivalent having or otherwise functionally linked to a user interface 112, a display unit 114 which may be integrated with or separate from the user interface 112, at least one processor 116, at least one computer-readable medium 118, a communications device 120 (for example, for receiving and/or transmitting data via communications networks), and data storage devices 122. The controller 110 may further be configured to generate control signals 130 to actuators associated with one or more control units 132, such as for example to regulate work machine travel operations (steering, propulsion), working operations, and the like.

The user interface 112 and onboard display unit 114 may be optional in some cases, particularly for example where the work machine is autonomous or otherwise not manually operated from onboard the work machine. In some embodiments, as noted below, a user interface 112 and onboard display unit 114 and associated functionality may enable users to initiate or perform certain operations with respect to the work machine, for example via user input mechanisms that allow the user to enter authentication information, start the work machine, set certain operating parameters for the work machine, or otherwise directly control the work machine.

Various operations, steps or algorithms as described in connection with elements of the system 100 can be embodied directly in hardware, in a computer program product such as software modules executed by respective processors, or in a combination of the two. For a respective device, a computer program product can reside in RAM memory, flash memory, ROM memory, EPROM memory, EEPROM memory, registers, hard disk, a removable disk, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The communications device 120 may support or provide communications between the controller 110 and external systems or devices, and/or support or provide communication interface with respect to internal components of the work machine. The communications device may include wireless communication system components (e.g., via cellular modem, WiFi, Bluetooth or the like) and/or may include one or more wired communications terminals such as universal serial bus ports.

The data storage 122 may, unless otherwise stated, generally encompass hardware such as volatile or non-volatile storage devices, drives, memory, or other storage media, as well as one or more databases residing thereon.

Software modules, one or more of which may collectively define an executable software package, and associated files residing in computer-readable medium 118 and/or data storage 122 in this context may be dependent on the type of work machine. For example, different types of work machines may include work implements, traveling devices, sprayers, cameras, and other imaging and/or perception devices, etc., along with corresponding controllers 110. Each onboard system for a given work machine may have one or more associated controllers 110, and in some contexts a single onboard controller 110 may be associated with one or more onboard systems.

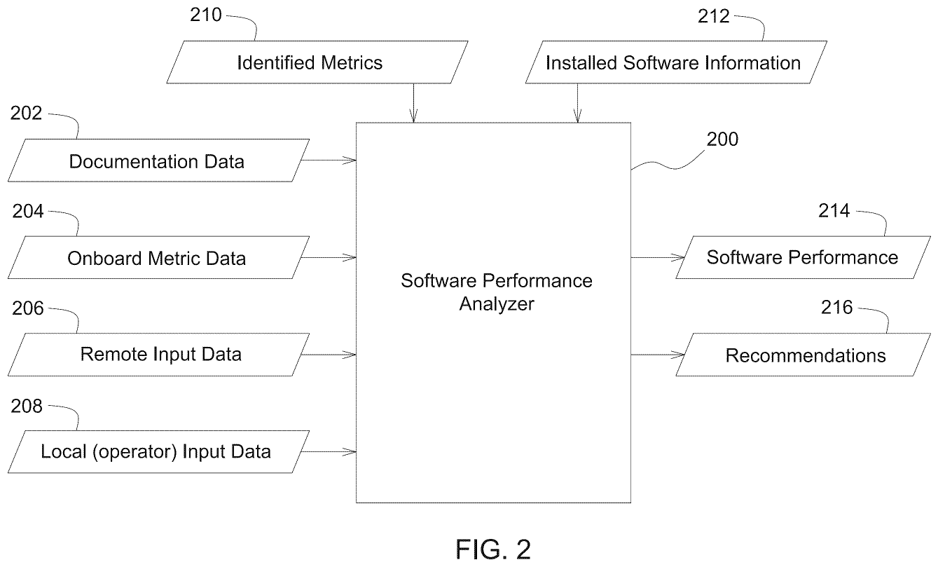

Referring to FIG. 2, the illustrated diagram represents an exemplary software performance analyzer 200 according to the present disclosure, which may in an embodiment reside in or in association with the cloud server network 140. The software performance analyzer 200 may reside on and be executable from a single source. In some embodiments, the software performance analyzer 200 may be in distributed form.

The software performance analyzer 200 may, depending on the application, receive and process input data including but not limited to documentation data 202 such as for example predetermined specifications for the work machine or associated components, onboard metric data 204 such as may be automatically detected, measured, or otherwise determined and provided from one or more onboard data sources, remote input data 206 such as for example may be retrieved from a host data source associated with a manufacturer of the work machine or an administrator of a fleet of work machines comprising the work machine at issue, local input data 208 such as for example may be provided by an operator via the onboard user interface 112, and/or the like. Examples of onboard metric data 204 may include performance data collected from one or more onboard processors and/or memory, relating for example to observed stop rates, command latency errors, synchronization dropout rates, accuracy of certain operations such as measured lateral error in machine guidance, etc. Examples of local input data 208 may include operator-specific metrics relating or otherwise contributing to user frustration, operational lag, etc.

The software performance analyzer 200 may, depending on the application, receive and process further input data such as for example identified metrics 210 for which performance levels may be predicted and compared against observed “actual” performance levels. Identification of the relevant metrics may for example be based on installed software information 212 provided in accordance with the provided update, and which may for example define expected improvements upon the previous software package.

In an embodiment, predicted performance levels may be based on an expectation regarding future performance levels of operational metrics once the software has been updated. In such cases, predicted performance levels may be compared against observed “actual” performance levels and an error determined, wherein substantially zero error is expected. In various embodiments, some margin of error may be allowed based for example on the relative criticality of the operational metric, as further described below.

In an embodiment, predicted performance levels may be based on historical data relating to the previous software version. For some operational metrics, there may be an expectation that future performance levels will correspond to historical performance levels after the software has been updated, wherein substantially zero error is expected. For other operational metrics, it may be expected that future performance levels will be better than historical performance levels, but an actual value for the predicted performance level is not specifically estimated. Rather, a difference between the predicted/historical performance levels and the actual performance levels may be ascertained and analyzed to determine if the degree of difference is appropriate or otherwise sufficient.

The software performance analyzer 200 as represented in FIG. 2 may further generate, based for example on some combination of the aforementioned inputs, one or more software performance metrics 214 based on the comparison of actual performance levels with predicted performance levels for each of the identified metrics corresponding to the updated software package. The software performance analyzer 200 as represented in FIG. 2 may further generate, based for example on the one or more software performance metrics 214, one or more recommendations 216 which may comprise intervention events (e.g., automatic changes to the software package, prompts for manual changes to the software package, or no changes at all) with respect to continued execution of the updated software package.

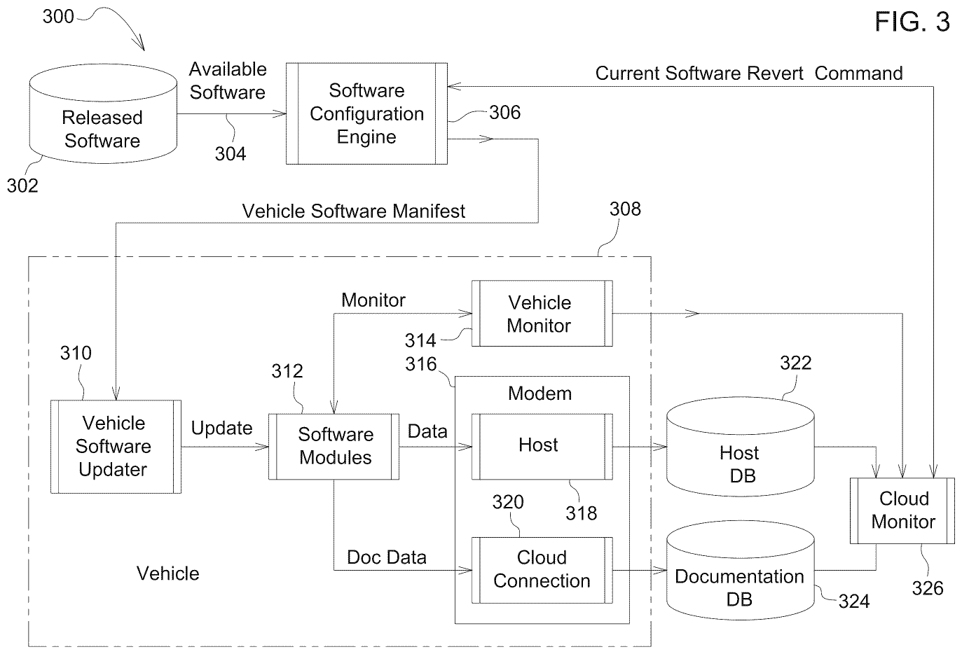

Referring next to FIG. 3, an exemplary embodiment of a data flow may be described in the context of a method 300 for dynamically selecting software based on determined performance levels with respect to operational metrics. The method 300 may be performed using or otherwise with respect to a control system 100 as represented in FIG. 1 and/or a software performance analyzer 200 as represented in FIG. 2, but the method 300 is not so limited in scope unless otherwise specifically noted herein. It should further be noted that the method 300 may be performed with respect to more than one work machine in some embodiments, wherein for example a software package may be dynamically selected and subsequently implemented for each work machine in a group (e.g., defined fleet) of work machines based on a preliminary analysis of performance levels with respect to operational metrics associated with a subset (at least one) of the various work machines in the group.

The method 300 begins with the release of one or more software modules, and/or the collection and storage of released software modules 302. The released software modules may for example be capable of implementation as part of a software package, for example with respect to a given type of work machine or a type of controller, or may collectively define a complete software package to be implemented as an upgraded version of a previous or otherwise existing software version.

One or more available software modules 304 may accordingly be accessed and retrieved or otherwise transmitted from the released software repository 302 illustrated in FIG. 3 to a software configuration engine 306. The software configuration engine 306 may typically be external to the work machine itself, as illustrated in FIG. 3, and for example provided in association with the cloud server network 140, but in some embodiments the engine 306 may be partially or entirely embodied on the work machine.

In the illustrated embodiment, one or more software modules and a machine software manifest may be transmitted from the cloud server 140, and more particularly the software configuration engine 306, to a work machine 308 and more particularly a software updater 310 resident thereon which may for example be associated with an onboard controller 110 or more generally with a machine control system 100. The software manifest may for example provide relevant information for determining operational metrics to be improved by updates corresponding to one or more of the received software modules 312, operational metrics to be monitored for determining whether the updated one or more software modules should remain in place or be subject to reversion or substitution, an identification of relatively critical operational metrics or critical performance aspects or ranges, or the like.

A cloud-based monitoring unit 326 may for example be configured to compare actual performance levels to predicted performance levels after the software updates have been applied. In some embodiments, at least some of the data provided to the cloud-based monitoring unit 326 may be provided from an onboard machine monitor 314, such as for example local user input data 208 provided via user interface 112. In some embodiments, at least some of the data provided to the cloud-based monitoring unit 326 may be provided from a hosted database 322, which itself receives performance-related onboard metric data 204 from a modem 316 (or alternative communications device) residing on the work machine 308 via a host connection 318. In some embodiments, at least some of the data provided to the cloud-based monitoring unit 326 may be documentation data 202 provided from a documentation database 324, which itself receives performance-related data from the modem 316 (or a separate modem or alternative communications device, not shown) via a cloud connection 320.

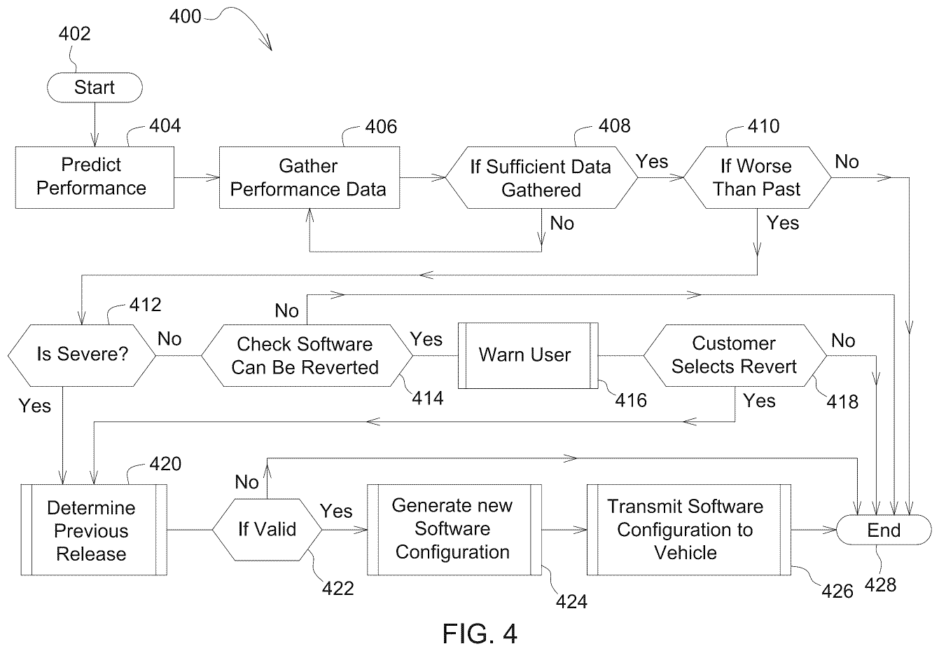

Referring next to FIG. 4, an exemplary embodiment of a cloud-based monitoring process in the context of a method 400 for dynamically selecting software based on determined performance levels with respect to operational metrics. The method 400 may be performed as an extension of the method 300, in whole or in part, or entirely independent thereof unless otherwise stated. The method may be performed using or otherwise with respect to a control system 100 as represented in FIG. 1 and/or a software performance analyzer 200 as represented in FIG. 2, but the method 400 is not so limited in scope unless otherwise specifically noted herein. While the steps in method 400 are generally described as being performed at the cloud server network 140 level, in various alternative embodiments at least some of the steps may be performed at the work machine level, at least some steps may be added to the illustrated method and performed at the cloud and/or work machine level, and at least some steps may even be omitted altogether unless otherwise specifically noted herein. The method 400 may be performed with respect to more than one work machine in some embodiments, wherein for example a software package may be dynamically selected and subsequently implemented for each work machine in a group (e.g., defined fleet) of work machines based on a preliminary analysis of performance levels with respect to operational metrics associated with a subset (at least one) of the various work machines in the group.

The method 400 may begin at step 402 in a manner consistent with the method 300 of FIG. 3, wherein one or more update software modules are received at an onboard controller 110 for a work machine, an updated software package is generated comprising at least one of the received one or more update software modules and stored in memory associated with the onboard controller, and data is further delivered to a cloud-based monitoring unit.

The method 400 may continue in step 404 with the prediction of respective performance levels for at least one operational metric corresponding with execution of the updated software package. The operational metrics may be predetermined based for example on the determination by software/product verification and validation (PV&V) teams of critical performance criteria that should be monitored to ascertain whether the updated software package us performing as predicted. Such determinations may be supplemented by, or in the alternative, models or algorithms may be trained over time to correlate metrics associated with the released software modules which demonstrate incremental change over the corresponding metrics associated with the preceding software package.

In an embodiment, a test operation may further be planned for the work machine wherein the updated software package is executed prior to a working operation for the work machine, with one exemplary object of such a test operation being to provide test inputs corresponding to actual performance levels for at least some of the operational metrics having predicted performance levels. In such embodiments, wherein for example performance levels of the operational metrics which are predicted to show at least incremental change with the updated software package may possibly only be determinable over an undesirably long period of time, the test operation may be beneficial for identifying whether or not the work machine will be able to properly perform the actual working operation and avoid a situation where the working operation may need to be paused for reversion back to the preceding software package.

In step 406, performance data associated with the work machine having the updated software package is gathered at the cloud level, wherein a corresponding actual performance level may be automatically detected for at least each of the operational metrics having predicted performance levels. If at a given time the cloud server network 140 determines that insufficient data has been gathered to make a determination with respect to the updated software package (i.e., “no” in response to the query in step 408), the method returns to performance data gathering step 406 until the server 140 determines that sufficient data has been gathered (i.e., “yes” in response to the query in step 408).

Beginning with step 410, the method 400 may, based on a comparison between the respective actual and predicted performance levels, continue with dynamically determining one or more recommendations (e.g., intervention events) with respect to a continued execution of the updated software package.

In one example, wherein the updated software package performs as predicted or otherwise is no worse than the preceding software package with respect to certain operational metrics (i.e., “no” in response to the query in step 410), the method 400 may conclude in step 428, optionally with a message to the operator of the work machine and/or one or more other authorized users to indicate that the software package has been successfully updated.

If the updated software package does not perform as predicted or performs worse than the preceding software package with respect to certain operational metrics (i.e., “yes” in response to the query in step 410), the method 400 may continue with various alternatives for dynamic selection of a replacement software package, whether simply removing one or more of the updated software modules, reverting to the previous software package, replacing the currently updated software package with a further updated software package, or the like, based for example on the severity of the difference between the detected actual performance levels and the corresponding predicted performance levels for each of the at least one operational metric. In an embodiment, the relative severity may for example be determined at least in part with respect to meeting or exceeding respective predetermined error ranges based on the comparison between the detected actual performance levels and the corresponding predicted performance levels for each of the monitored operational metrics.

If the updated software package does not perform as predicted or performs worse than the preceding software package with respect to certain operational metrics, but the lack of performance is not deemed severe, or for example if the work machine can still adequately perform its working operations with the updated software package (i.e., “no” in response to the query in step 412), the method 400 may continue in step 414 by checking to see if the software can be reverted to the previous version.

If the previous software version is unavailable (i.e., “no” in response to the query in step 414), the method 400 may conclude in step 428, wherein operation of the work machine continues with the current updated software package, as the underperformance or lack of expected improvements is (at least in this determined instance) not critical.

If the previous software version is available (i.e., “yes” in response to the query in step 414), the method 400 may continue in step 416 by prompting the operator or other authorized user with the option to revert back to the previous software package, or to retain the current updated software package. If the operator elects not to revert (i.e., “no” in response to the query in step 418), the method 400 may conclude in step 428, wherein operation of the work machine continues with the current updated software package, as the underperformance or lack of expected improvements is (at least in this determined instance) not critical.

If the operator elects to revert (i.e., “yes” in response to the query in step 418), the method 400 may continue in step 420 by identifying the previous software version and further determining if the previous software version is available and still technically valid in step 422. Similarly, if the measured performance with respect to the previous software version is significantly worse in at least one critical operational metric (i.e., “yes” in response to the query in step 412), such that for example the work machine cannot (or should not) be utilized to perform its working operations with the updated software package, the cloud server 140 can proceed to step 420 and command the work machine to roll back to the previous software version.

If the previous software version is available and valid (i.e., “yes” in response to the query in step 422), the method 400 may continue in step 424 by generating a new software configuration based entirely on the previous software package, or in some embodiments utilizing some software modules from the previous software package while keeping some of the software modules which were updated. The software configuration may then be transmitted to the work machine in step 426, wherein the method concludes in step 428 or may revert to step 402 for testing of the new (e.g., previous) software package.

If the previous software version is unavailable or invalid (i.e., “no” in response to the query in step 422), the method 400 may conclude in step 428. In some embodiments, the operator or other authorized user may be informed of the severity of the performance issues with the updated software package. In some cases, the previous software version may be unavailable because it was not properly stored when updated or was corrupted in some manner. More typically, a software rollback may be prevented due to issues with data migration, the presence of one or more dependent services that cannot be rolled back, the presence of one or more required embedded controllers that are not updateable, security updates which are required in future operations and were lacking in the previous version, etc.

In some embodiments, rather than merely concluding the method 400 when the previous software version is unavailable or invalid (i.e., “no” in response to either of the queries in steps 414 and 422), or when the operator elects not to revert (i.e., “no” in response to the query in step 418), the method 400 may further include a step (not shown) of automatically releasing one or more software modules for assembling an alternative updated software package at the work machine.

For example, multiple software packages may be available for a certain type of work machine, and if a first update does not perform satisfactorily based on empirical data from the work machine, a second update may be provided at least attempting to address the performance issue.

As another example, different work machines of similar type may have different numbers and configurations of controllers based on the types of attachments, the working operations to be performed, the age of the various components, etc., wherein a first update may be found to not perform satisfactorily at least because of incompatibility with one or more these elements of the work machine, and a second software update may be attempted. In such an example, the second or “first alternative” software update may itself be determined to be unavailable for the particular configuration of the work machine or operation to be performed, wherein a compatible software package may be dynamically generated for the purpose of a second alternative software update.

In an embodiment, one of more software modules to be provided as part of such an alternative software update may be automatically identified and retrieved for transmittal to the work machine based in part on the empirical data provided from the work machine in testing the performance levels, on user input from the operator or other authorized user which may be provided in conjunction with the performance test, or the like.

As previously noted herein, in some embodiments a test operation may be performed to determine performance levels for certain operational metrics prior to undertaking a working operation using the software update.

In other embodiments where a test operation is not performed, or where for example certain determinations of poor performance in one or more operational metrics, the cloud server may determine that a reversion to the previous software package or a switch to an alternative updated software package is desired but is not ripe for change during an operation currently being performed.

The operator may then be prompted to selectively initiate a new software update when the working operation is concluded, or the system may automatically switch to the alternative software package upon determining completion of the working operation currently being performed by the work machine.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A computer-implemented method for dynamic software selection for a work machine based on determined operational metrics, the method comprising:
receiving one or more update software modules at an onboard controller for a work machine, and generating an updated software package comprising at least one of the received one or more update software modules in memory associated with the onboard controller;
predicting a performance level for at least one operational metric corresponding with execution of the updated software package;
automatically detecting a corresponding actual performance level for each of the at least one operational metric; and
based on a comparison between the respective actual and predicted performance levels, dynamically determining an intervention event with respect to a continued execution of the updated software package.

2. The method of claim 1, wherein:
the one or more update software modules are received and utilized to generate an updated software package by at least one of a plurality of work machines;
a comparison with respect to respective predicted performance levels is provided for each of the at least one of the plurality of work machines having executed the updated software package and producing actual performance levels; and
an intervention event is dynamically determined with respect to a continued execution of the updated software package for each of the plurality of work machines.

3. The method of claim 1, comprising determining no intervention event is required based on the detected actual performance levels meeting or exceeding the corresponding predicted performance levels for each of the at least one operational metric.

4. The method of claim 1, wherein for a first error range based on the comparison between the detected actual performance levels and the corresponding predicted performance levels for each of the at least one operational metric, the determined intervention event comprises an automatic switching from the updated software package to an alternative software package.

5. The method of claim 4, wherein switching to the alternative software package comprises reversion to a preceding software package lacking the at least one of the received one or more update software modules.

6. The method of claim 4, wherein the determined intervention event comprising the automatic switching from the updated software package to the alternative software package is dependent on the alternative software package being determined as valid for further execution with respect to the work machine.

7. The method of claim 6, wherein upon determining that a first alternative software package is invalid for further execution with respect to the work machine, the determined intervention event comprises automatic switching from the updated software package to a second alternative software package.

8. The method of claim 6, wherein a determination as to whether the alternative software package is valid is dependent at least in part on an operation being performed or to be performed by the work machine.

9. The method of claim 8, comprising determining that switching to the alternative software package is not valid during an operation currently being performed, and further switching to the alternative software package upon completion of the operation currently being performed.

10. The method of claim 1, comprising planning a test operation for the work machine wherein the updated software package is executed for the dynamically determining of the intervention event prior to a working operation for the work machine.

11. The method of claim 10, wherein the test operation is planned to provide test inputs corresponding to actual performance levels for each of the at least one operational metric.

12. The method of claim 1, wherein one or more of the at least one operational metric are defined based on operator input to the controller via a user interface.

13. The method of claim 12, wherein the corresponding actual performance levels for the one or more of the at least one operational metric are provided based on operator input to the controller via the user interface.

14. A system comprising:
one or more work machines each respectively comprising an onboard controller and memory associated therewith; and
one or more processors configured, for each of the one or more work machines, to:
cause one or more update software modules to be received at the onboard controller, and generate an updated software package comprising at least one of the received one or more update software modules in memory associated with the onboard controller;
predict a performance level for at least one operational metric corresponding with execution of the updated software package;
automatically detect a corresponding actual performance level for each of the at least one operational metric; and
based on a comparison between the respective actual and predicted performance levels, dynamically determine an intervention event with respect to a continued execution of the updated software package.

15. The system of claim 14, wherein:
the one or more update software modules are received and utilized to generate an updated software package by at least one of a plurality of work machines;
a comparison with respect to respective predicted performance levels is provided for each of the at least one of the plurality of work machines having executed the updated software package and producing actual performance levels; and
an intervention event is dynamically determined with respect to a continued execution of the updated software package for each of the plurality of work machines.

16. The system of claim 14, wherein at least one of the one or more processors is associated with a cloud network communicatively linked with the onboard controller.

17. The system of claim 14, wherein a first error range is based on the comparison between the detected actual performance levels and the corresponding predicted performance levels for each of the at least one operational metric, and the determined intervention event comprises an automatic switching from the updated software package to an alternative software package.

18. The system of claim 17, wherein switching to the alternative software package comprises reversion to a preceding software package lacking the at least one of the received one or more update software modules.

19. The system of claim 17, wherein:
the determined intervention event comprising the automatic switching from the updated software package to the alternative software package is dependent on the alternative software package being determined as valid for further execution with respect to the work machine; and
upon determining that a first alternative software package is invalid for further execution with respect to the work machine, the determined intervention event comprises automatic switching from the updated software package to a second alternative software package.

20. The system of claim 14, wherein the one or more processors are configured to plan a test operation for the work machine wherein the updated software package is executed for the dynamically determining of the intervention event prior to a working operation for the work machine, wherein the test operation is planned to provide test inputs corresponding to actual performance levels for each of the at least one operational metric.
